(19) United States
(12) Patent Application Publication
(10) Pub. No.: US 2010/0042636 A1
(43) Pub. Date: Feb. 18, 2010

(54) INTERNET SERVER SYSTEM, METHOD OF CREATING VIRTUAL MACHINE OF THE INTERNET SERVER AND METHOD OF STARTING THE SAME

(75) Inventor: Ying-Chih Lu, Taipei City (TW)

Correspondence Address: J C PATENTS, 4 VENTURE, SUITE 250, IRVINE, CA, 92618, US

(73) Assignee: Inventec Corporation, Taipei City (TW)

(21) Appl. No.: 12/243,225

(22) Filed: Oct. 1, 2008

(30) Foreign Application Priority Data
Aug. 13, 2008 (TW) 97130877

(51) Int. Cl. G06F 15/173; G06F 17/30

(52) U.S. Cl. 707/100; 709/223; 707/E17.044

(57) ABSTRACT

An internet server system for providing a virtual machine (VM) to a user, a method of creating a VM and an account, and a method of starting a VM via a webpage are provided. The internet server system includes at least one client apparatus, a computing server, a thin client management server, a storage unit, and a storage server. The method of creating a VM and an account includes: cloning a VM according to the request signal and logging in the VM with a preset account and a preset password; creating an FQDN for the VM; logging out the VM; and saving setting of the VM to a database server. The method of starting a VM via a webpage includes: connecting to a thin client webpage via a web browser; confirming an account and a password; starting the VM notifying a user to connect by a remote desktop connection.

### CROSS-REFERENCE TO RELATED APPLICATION

This application claims the priority benefit of Taiwan application serial no. 97130877, filed on Aug. 13, 2008. The entirety of the above-mentioned patent application is hereby incorporated by reference herein and made a part of specification.

### BACKGROUND OF THE INVENTION

1. Field of the Invention

The present invention generally relates to an internet server system, and more particularly, to an internet server system adapted for providing a virtual machine (VM) to users, and a method for creating an account for the VM, and a method for starting the VM via a webpage.

2. Description of Related Art

Nowadays, in the field of computer, the internet which connects computers all over the world together allows a user to browse computers in other places of the world for accessing and exchanging data or information via a cable connecting his computer to the internet. The presence of servers and clients further allows executing many different computations at different positions of a server and a client. A strong server may serve for many clients at the same time.

An internet user may get access to a remote server via a client computer connected thereto, thus using the services provided by the remote server (e.g., web browsing, receiving/sending emails, online shopping, network banking, and online games. However, in this case, the client is typically required for a complete host computer system executing an operation system, for connecting with the remote server, and executing a user interface of the client. Unfortunately, this restricts the application of clients. As such, if the client could be developed to be cheaper, lighter, the remote server system would be more popular and more convenient for using.

Further, for business users who usually use personal computers, because each of the personal computers employs an independent system and independent hardware, it would have been a very complicated task of managing so many information equipments. In this concern, maintenance of the equipments, updating of the operation system, backup, sharing and managing of data would bring a heavy load and repetitive works to the information management staff.

### SUMMARY OF THE INVENTION

Accordingly, the present invention is directed to provide an internet server system. The internet server system is realized by integrating thin client (TC), virtual machine (VM), server, and redundant array of independent disk (RAID) technologies and so on, thus allowing the server administrator to divide users into different levels, and setting up independent operation systems corresponding to different VMs, so as to enforce the integrity of enterprise information systems.

The present invention provides an internet server system, including at least one client apparatus, a computing server, a thin client management server, a storage unit, and a storage server. The computing server and the thin client management server are adapted for providing a VM to the client apparatus and determining a system source corresponding to the VM. The client apparatus is connected to the computing server and the thin client management server via an external (or internal) network. The storage server is connected to the thin client management server and the computing server via an internal network.

The present invention further provides a method of creating a VM and an account thereof. The method includes: receiving a request signal; cloning a VM according to the request signal and logging in the VM with a preset account and a preset password; creating a Fully Qualified Domain Name (FQDN) for the VM; logging out the VM; and saving a user account, a user password, the FQDN, and a configuration file name corresponding to the VM to a database server.

The present invention further provides a method of starting a VM via a webpage. The method includes: connecting to a thin client webpage via a web browser; confirming a user account and a user password; creating or starting a virtual machine (VM) and creating or attaining a FQDN corresponding to the VM, when the user account and the user password are confirmed as being correct; notifying a user to start a remote desktop connection by the FQDN of the VM; connecting to the VM via a remote desktop client; and logging in the VM with the user account and the user password.

The present invention further provides an internet server system, including at least one client apparatus, a computing server, a thin client management server, a storage unit, and a storage server. The computing server is adapted for providing a VM to the client apparatus. The thin client management server is adapted for managing the VM and determining a system source corresponding to the VM. The storage server is connected to the storage unit, for managing an access authority of the storage unit. The client apparatus is connected to the computing server and the thin client management server via an internal network. The storage server is connected to the thin client management server and the computing server via an internal network.

According to an embodiment of the present invention, in the foregoing internet server system, a communication protocol applied between the client apparatus, the computer server, and the thin client management server includes a Remote Desktop Protocol (RDP) or an Independent Computing Architecture (ICA), and a Hypertext Transfer Protocol (HTTP).

According to an embodiment of the present invention, in the foregoing internet server system that the communication protocol applied between the client apparatus, the computer server, and the thin client management server includes an RDP or an ICA, and an HTTP, a communication protocol applied between the computing server and the thin client management server includes an Extensible Markup Language Remote Procedure Call (XML-RPC) communication protocol.

According to an embodiment of the present invention, in the foregoing internet server system, a communication protocol applied between the storage server, the thin client management server, and the computing server includes an Internet Small Computer System Interface (ISCSI) protocol.

According to an embodiment of the present invention, in the foregoing internet server system, the client apparatus includes a thin client apparatus, a personal computer, or a notebook computer.

According to an embodiment of the present invention, in the foregoing internet server system, the computing server includes a plurality of blade servers.

According to an embodiment of the present invention, in the foregoing internet server system that the computing server includes a plurality of blade servers, the thin client management server is adapted for adjusting a quantity of VMs assigned to each of the blade servers for computation, according to computation loads of the blade servers.

According to an embodiment of the present invention, in the foregoing internet server system, the thin client management server is further adapted for managing a user account, transferring the VM, monitoring a status of the VM and connecting the VM to a thin client.

According to an embodiment of the present invention, in the foregoing internet server system, the storage unit includes a plurality of hard disks. The hard disks are Serial Attached SCIS (SAS) interfaces, or Serial Advanced Technology Attachment (SATA) interfaces. According to an embodiment of the present invention, the thin client management server provides an RDP client environment, an ICA client environment, or an HTTP client environment to the client apparatus.

According to an embodiment of the present invention, in the foregoing internet server system, the thin client management server includes a virtual machine management module (conVirt(GUI)/xm).

According to an embodiment of the present invention, in the foregoing internet server system, the VM is an open source VM (Xen virtual machine).

According to an embodiment of the present invention, in the foregoing internet server system, the VM includes a virtual disk space and an operation system.

According to an embodiment of the present invention, in the foregoing internet server system that the VM includes a virtual disk space and an operation system, the operation system includes a Microsoft® Windows® operation system, or a Linux operation system.

According to an embodiment of the present invention, in the foregoing internet server system that the VM includes a virtual disk space and an operation system, the storage unit is a RAID system.

According to an embodiment of the present invention, in the foregoing internet server system, when an address of the VM or the FQDN of the VM is varied, the VM notifies a domain name server (DNS).

According to an embodiment of the present invention, in the foregoing internet server system, the storage server is an ISCSI server, a Network Attached Storage (NAS) server, or a Fibre Channel server.

According to an embodiment of the present invention, the foregoing internet server system further includes a database server. The database server is a Network Information Server (NIS), or a Structured Query Language (SQL) server for saving the account, the password, the FQDN, the configuration file name, and an internet address corresponding to the VM therein.

Viewing from another point, the present invention provides a method of creating a virtual machine and an account thereof. The method includes: receiving a request signal; cloning a VM according to the request signal and logging in the VM with a preset account and a preset password; setting up a Fully Qualified Domain Name (FQDN) for the VM; logging out the VM; and saving a personal account, a personal password, the FQDN, and a configuration file name corresponding to the VM to a database server.

Viewing from a further point, the present invention still provides a method of starting a VM via a webpage. The method includes: connecting to a thin client webpage via a web browser; confirming a user account and a password; creating or starting a virtual machine (VM) and creating or attaining a Fully Qualified Domain Name (FQDN) corresponding to the VM, when the user account and the user password are confirmed as being correct; notifying a user to start a remote desktop connection by the FQDN of the VM; connecting to the VM via a remote desktop client; and logging in the VM with the user account and the password.

According to an embodiment of the present invention, in the foregoing method of starting a VM via a webpage, when the user account and the password are failed to be confirmed as being correct, a logging error reminder is outputted.

According to an embodiment of the present invention, the step of starting VM when the user account and the password are confirmed as being correct of the foregoing method further includes: directly retrieving the FQDN corresponding to the VM, if the VM corresponding to the user account has been already started; or starting the VM, if the VM corresponding to the user account is not yet started.

The internet server system combines a function of the computing server of providing a VM, a function of the thin client management server of managing the VM, and a function of the storage server of connecting to the storage unit, and applies RDP protocol or ICA protocol, and HTTP protocol in an external (or an internal) network, and applies ISCSI protocol and XML-RPC protocol in an internal network, thus achieving a complete virtual machine server system. The present invention further provides a method of creating a VM and an account thereof, and a method of starting a VM via a webpage, so that the VM can be more conveniently constructed, accessed, and used by the client apparatus.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating an internet server system according to a first embodiment of the present invention.

FIG. 2 is an architectural diagram illustrating an open source hypervisor server according to the first embodiment of the present invention.

FIG. 3 is a system architectural diagram illustrating a thin client management server according to the first embodiment of the present invention.

FIG. 4 is a schematic diagram illustrating an Internet Small Computer System Interface (ISCSI) configuration according to the first embodiment of the present invention.

FIG. 5 is a schematic diagram illustrating a VM live migration according to the first embodiment of the present invention.

FIG. 6 illustrates a connection relationship between a database server and a thin client account management program of the thin client management server according to the first embodiment of the present invention.

FIG. 7 is a schematic diagram illustrating architectures of a Domain Name Server (DNS) 710 and a Dynamic Host Configuration Protocol (DHCP) server 720 according to the first embodiment of the present invention.

FIG. 8 is a block diagram illustrating the internet server system according to the first embodiment of the present invention.

FIG. 9 is a flow chart illustrating a method of creating a VM and an account thereof according to a second embodiment of the present invention.

FIG. 10 is a flow chart illustrating a method of starting a VM via a webpage according to a third embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

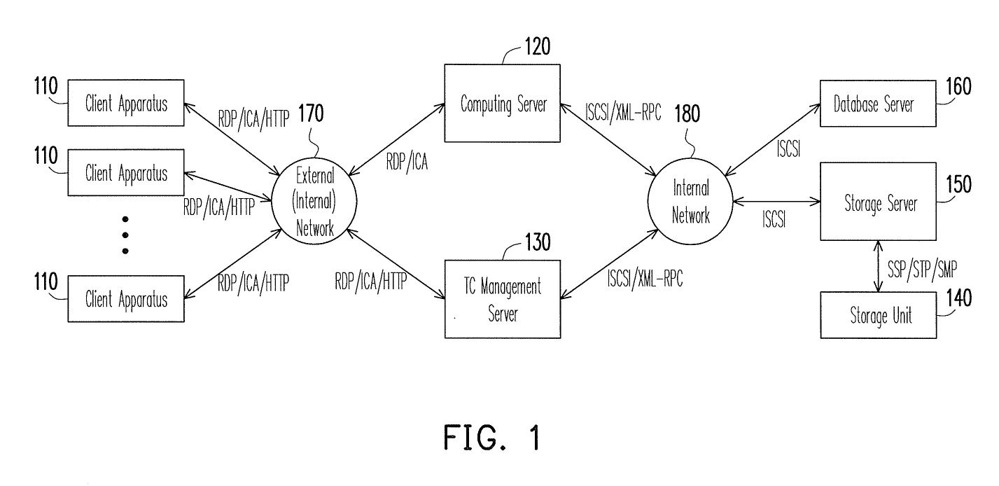

FIG. 1 is a block diagram illustrating an internet server system according to a first embodiment of the present invention. Referring to FIG. 1, the internet server system includes at least one client apparatus 110, a computing server 120, a thin client management server 130, a storage unit 140, a storage server 150, and a database server 160. The client apparatus 110 is connected to the computing server 120 and the thin client management server 130 via an external (or internal) network 170. The storage unit 140 is connected to the storage server 150. The storage server 150, the computing server 120, the thin client management server 130, and the database server are connected to by an internal network 180.

The client apparatus 110 is a terminal unit directly used by a user, and is an interface for communicating with the user. The computing server 120 is mainly adapted for providing computing sources for a virtual machine (VM) required by the client apparatus 110. A server administrator is capable of managing the VM by the thin client management server 130, determining system sources corresponding to the VM, and executing an adding, deleting, or transferring operation of the VM. The storage unit 140 is adapted for storing an operation system corresponding to the VM and related data such as a configuration data thereof, and providing a storage space for the user. The storage server 150 is connected to the storage unit 140, for managing an access authority of the storage unit 140. The database server 160 is adapted for storing related data of the VM, such as a user account and a password of the VM, a Fully Qualified Domain Name (FQDN) of the VM, or a Virtual Machine Media Access Control address (VM MAC address), a VM configuration file name, a Xen server network address. In the current embodiment, the storage unit 140 includes a plurality of disks which constitute a redundant array of independent disk (RAID) system.

The internet server system is adapted to provide a VM to the user for use. The VM for example is a 2003 version of Microsoft® Windows® operation system, or a RedHat Linux EL5 operation system. The VM is an operation environment simulated by software, in which actions such as command operation and discrimination, memory application, data access are not executed in the client apparatus 110, and hardware equipment executing the actions such as Central Processing Unit (CPU), memory, storage apparatus, are realized by the internet server system instead of the client apparatus 110. The computing server provides computing sources and an operational environment, and the storage unit 140 provides a storage space for the VM. The thin client management server 130 is adapted for managing adding, deleting, and transferring operations of the VM. Then, the client management server 130 is connected to the client apparatus 110 via a network in accordance with RDP, or ICA and HTTP communication protocol, and provides the client a simulated operational environment like a real computer operation system.

In the current embodiment, the client apparatus 110 for example is a personal computer (PC), a notebook computer, or any thin client (TC) which can use RDP or ICA and HTTP communication protocol. The computing server 120 includes a plurality of blade servers. The storage unit 140 for example is a storage device including a plurality of SAS interface hard disks or a plurality of SATA interface hard disks, or a redundant array of independent disk (RAID) system. The thin client management server 130 for example includes a virtual machine management module (for example, conVirt(GUI)/xm). The storage server 150 for example is an Internet Small Computer System Interface (ISCSI) server, a Network Attached Storage (NAS) server, or a Fibre Channel server. The database server 160 for example is a Structured Query Language (SQL) 2000 database server or a Network Information Server (NIS).

The client apparatus 110, the computing server 120, and the thin client management server 130 are connected by the external (or internal) network 170 and the RDP or ICA and HTTP communication protocols. The computing server 120 and the thin client management server 130 are connected by XML-RPC communication protocol and the internal network 180. The storage unit 140 is connected to the storage server 150. The storage server 150, the computing server 120, the thin client management server 130, and the database server 160 are connected to the internal network 180 by an ISCSI.

Xen is an open source hypervisor and operation platform developed by the University of Cambridge. It allows running up to 128 guest operation systems having full functions on an individual host computer. There are two approaches in doing that, one of which is to explicitly modify (implant) the operation system for running on the Xen while providing compatibility for the user's application, and in such a way the Xen can achieve a high performance virtualization without being supported by specific hardware. Another approach is to support the CPU with Virtualization Technology (VT), so that the operation system can be run on the Xen without being modified. A VM running on such a Xen is called a Hardware Virtual Machine (HVM). The VM configured with a Xen architecture is called a Xen VM or a VM in the current embodiment herebelow.

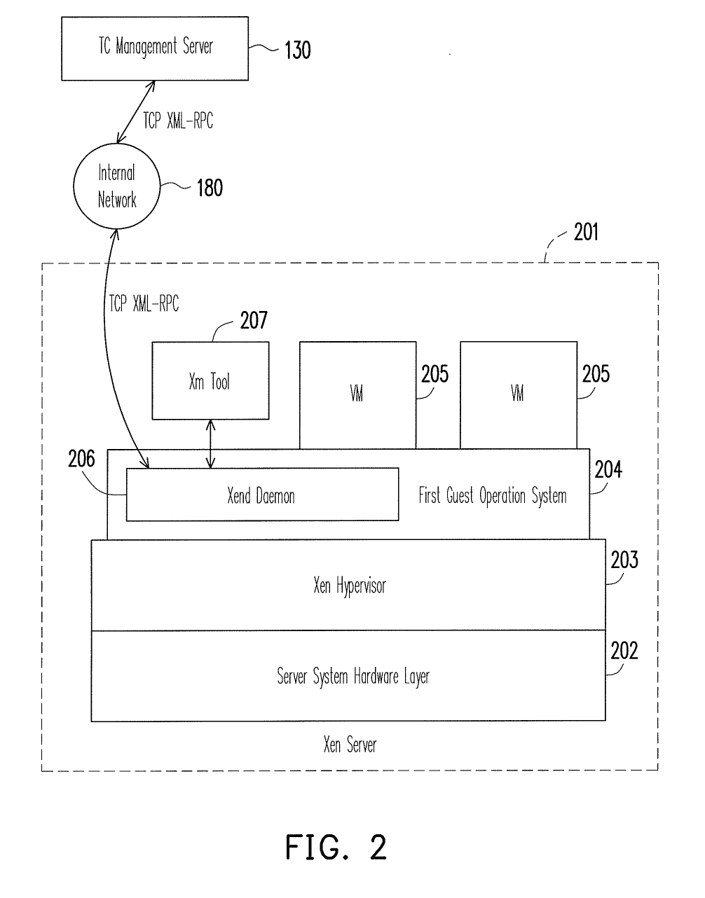

FIG. 2 is an architectural diagram illustrating an open source Xen server according to the first embodiment of the present invention. The blade servers of the computing server 120 can be taken as a Xen server 201. As shown in FIG. 2, the bottommost layer is a server system hardware layer 202. The second layer is a Xen hypervisor 203, which is a layer of the lowest rank and being most functionally powerful. The Xen hypervisor 203 allows a plurality of guest operation systems provided thereabove and executed in a same computer hardware at the same time.

The Xen hypervisor 203 allocates the guest operation systems to a plurality of CPUs. In the terminology of Xen, the guest operation system 204 is called “domain 0” (dom0 hereinafter). There are many management authorities assigned to dom0 204, so that dom0 204 is allowed to use sources of the hardware layer. When the Xen hypervisor 203 is started, dom0 204 is also started, and therefore a system administrator will log in dom0 204 to start other guest operation systems, i.e., VMs 205, which are called “domain U” (domU hereinafter). As such, all VMs domU 205 are configured on dom0 204. In each of the VMs domU 205, an application program of the guest operation system therein can be executed.

For example, the first guest operation system dom0 204 is a XenLinux operation system. The XenLinux operation system executes a Xen controller resident program (Xend daemon) 206 and provides a Xen management API, connects to a VM management tool program (Xm tool) 207, and connects to the thin client management server 130 via the internal network 180 by Transfer Control Protocol (TCP) and XML-RPC communication protocol, for receiving and transmitting information. In other words, only the thin client management server 130 is the main management center of the VM. However, the thin client management server 130 must transfer and execute commands via the Xend daemon 206 and the Xm tool 207.

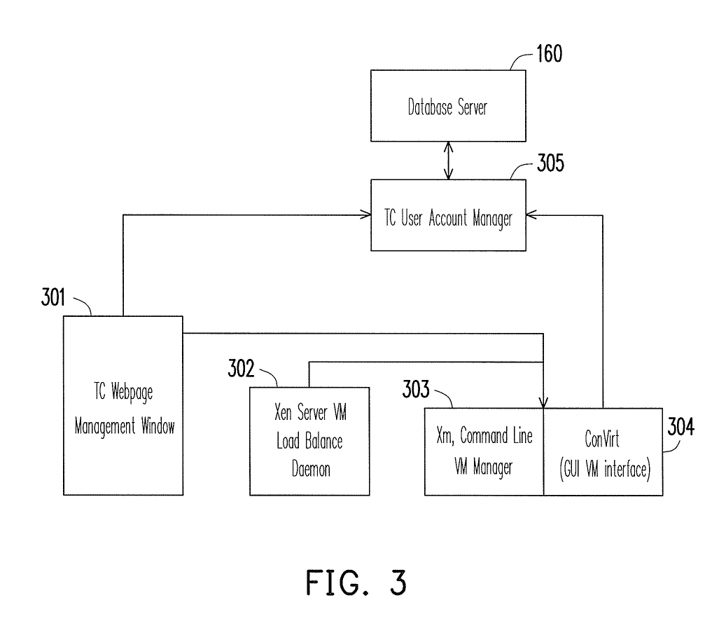

FIG. 3 is a system architectural diagram illustrating a thin client management server according to the first embodiment of the present invention. Referring to FIG. 3, the illustrated architecture includes a thin client webpage management window 301, a Xen server VM load balance daemon 302, an Xm (command line VM manager) 303 and a ConVirt(GUI VM interface) 304. Any variation of the VM, e.g., adding or deleting operation, would be saved in the database server 160 via a thin client user account manager 305.

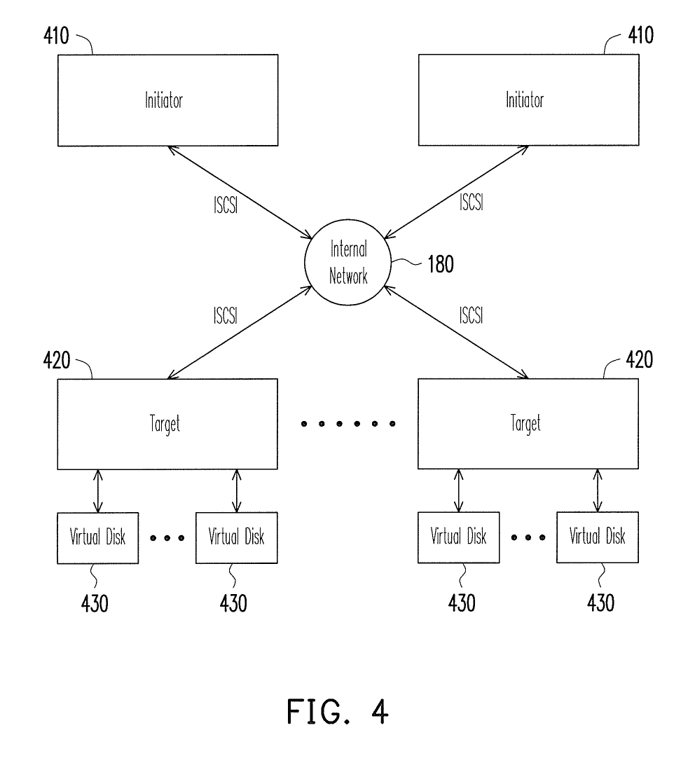

FIG. 4 is a schematic diagram illustrating an ISCSI configuration according to the first embodiment of the present invention. The ISCSI is a communication protocol exchanging SCSI commands via Internet Protocol (IP). A core technique of the ISCSI is to transmit the SCSI protocol in a Transfer Control Protocol/Internet Protocol (TCP/IP) network, so that the SCSI command and data can be transmitted via an ordinary Ethernet. In such a way, the ISCSI can achieve a Storage Area Network (SAN) with a transmission line of a high-speed Local Area Network (LAN). Further, such an ISCSI does not require an additional transmission line, and is cheaper than optical fibre. The ISCSI is most widely used in server computers for accessing RAIDs, for complying with the functions such as disk defragmention, backup and recovery.

Referring to FIG. 4, there are shown initiators 410 which are clients capable of transmitting an ISCSI command. Targets 420 are storage servers of the ISCSI connected with virtual disks 430. Different initiators 410 and targets 420 are connected to the internal network 180 via the ISCSI.

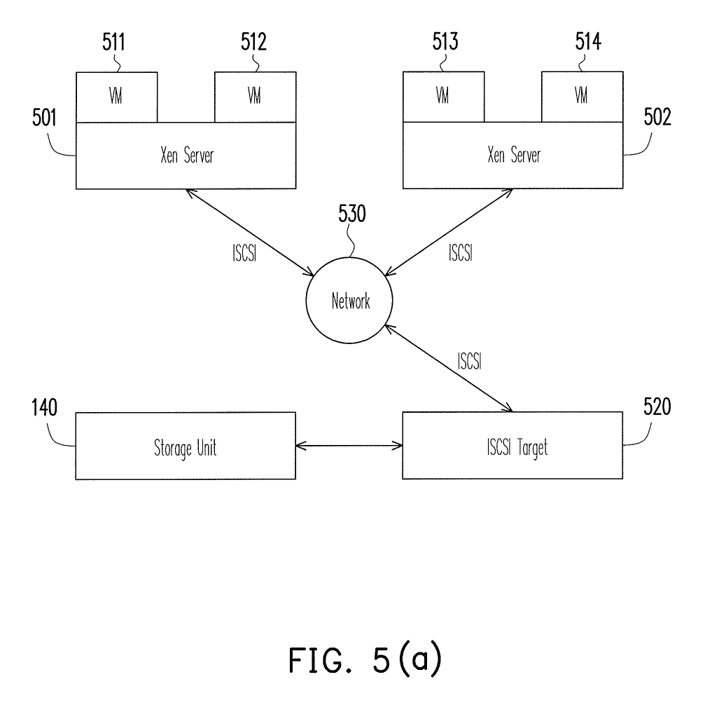

FIG. 5 is a schematic diagram illustrating a VM live migration according to the first embodiment of the present invention. FIG. 5(a) of FIG. 5 is a block diagram before the live migration, and FIG. 5(b) of FIG. 5 is a block diagram after the live migration. Referring to FIG. 5(a), there are shown two Xen servers 501 and 502. There are two VMs 511 and 512 executed on the Xen server 501, and there are two VMs 513 and 514 executed on the Xen server 502. Both of the two Xen servers 501 and 502 are connected to the network 530 via an initiator of the ISCSI, and thus are connected to an ISCSI target 520 of the storage apparatus. In this case, if the system finds that VM loads of the two Xen servers 501 and 502 are unbalanced, the system may decide to migrate the VM 512 to the Xen server 502. Then, the system can connect to the network 530 via the ISCSI protocol, and clone the VM 512 to the Xen server 502. As shown in FIG. 5(b), after the migration, the Xen server 501 includes the VM 511, while the Xen server 502 includes the VMs 512, 513, and 514.

The thin client management server 130 is adapted for comparing loads of VMs in different Xen servers, so as to decide whether to execute and how to execute a live migration. For example, the thin client management server 130 compares utilization ratios of CPUs, so as to detect which server bears the heaviest load. Further, a most direct criterion is to compare amounts of VMs loaded on the different servers. If an individual server loads VMs exceeding a preset amount, a VM migration is then executed for balancing the loads on the servers. A general principle is that the thin client management server 130 always lively migrates a VM from a server having a heavier load to a server having a lighter load.

The live migration can be performed during a short intermission in an execution of a VM, to clone the VM to another Xen server. Then, the original VM is deleted, thus achieving the live migration of VM. Generally, the short intermission lasts for about 60 to 300 ms only. And therefore, the live migration can be felt as almost a seamless migration. The live migration is adapted for uniformly distributing workloads of a plurality of VMs on a plurality of Xen servers, without affecting the operation of VMs by the user.

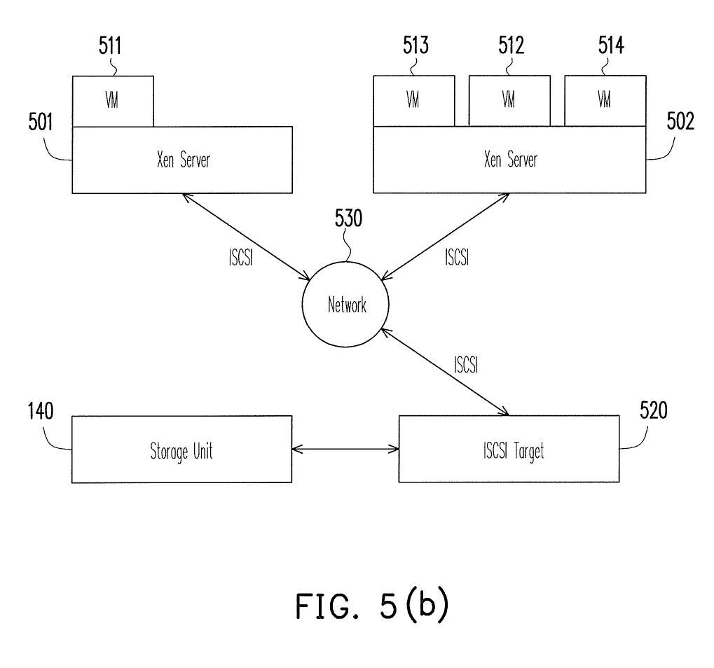

FIG. 6 illustrates a connection relationship between a database server and a thin client account management program of the thin client management server according to the first embodiment of the present invention. Referring to FIG. 6, the database server 610 for example is an SQL 2000 database server, and a database client 620 for example is an SQL 2000 server client. The database server 610 is connected to a storage unit 630 with SAS interface or SATA interface. A thin client account management program is connected to the database server 610 via the network 530.

Table 1 shows a data storage format of the database server 610. The first column lists user accounts, i.e., names of the VMs, which can be named according to nicknames of the users and types of the operation systems of the VMs. The second column lists passwords. The third column lists Fully Qualified Domain Names (FQDN), or VM Media Access Control (MAC) addresses. The fourth column lists names of configuration files of the VMs, which can be named by the accounts. Data contained in the configuration files include CPU amounts, virtual Network Information Center (NIC) amounts, memory sizes, storage spaces and positions of storage apparatuses, and real positions of virtual NICs. The fifth column lists network addresses of Xen servers executing the VMs. One Xen server can execute one or more than one VM. As such, there may be more than two VMs corresponding to a same Xen server. As shown in Table 1, both of the first VM and the fourth VM correspond to a Xen server having a same network address of 10.6.113.136.

TABLE 1
Database Storage Format

| | | | VM | Xen server |
|---|---|---|---|---|
| Account | | FQDN or VM MAC | configuration | network |
| name | Password | address | file name | address |
| YJLu-WinXpC | YJLu_1624 | iesc-880009-1.Inventecesc.com | YJLu-WinXpC.hvm | 10.6.113.136 |
| | | or | | |
| | | (00-16-3E-22-BB-3A) | | |
| GeorgeYu-W2003R2- | GeorgeYu_1234 | iesc-939052-1.Inventecesc.com | GeorgeYu-W2003R2- | 10.6.113.30 |
| 64 | | or | 64.hvm | |
| | | (00-16-3E-22-BB-3B) | | |
| RobertLiu- | RoberLiu_5678 | iesc-939050-1.Inventecesc.com | RobertLiu- | 10.6.113.102 |
| W2003R2- | | or | W2003R2-32.hvm | |
| 32 | | (00-16-3E-22-BB-3C) | | |
| JohnnyChang- | JohnnyChange_0987 | iesc-959002-1.Inventecesc.com | JohnnyChange- | 10.6.113.136 |
| Vista-32 | | or | Vista-32.hvm | |
| | | (00-16-3E-22-BB-3D) | | |
| BenLee-RHEL5AS- | BenLee_4321 | iesc-900130-1.Inventecesc.com | BenLee-RHEL5AS- | 10.6.113.50 |
| 64 | | or | 64.hvm | |
| | | (00-16-3E-22-BB-3E) | | |

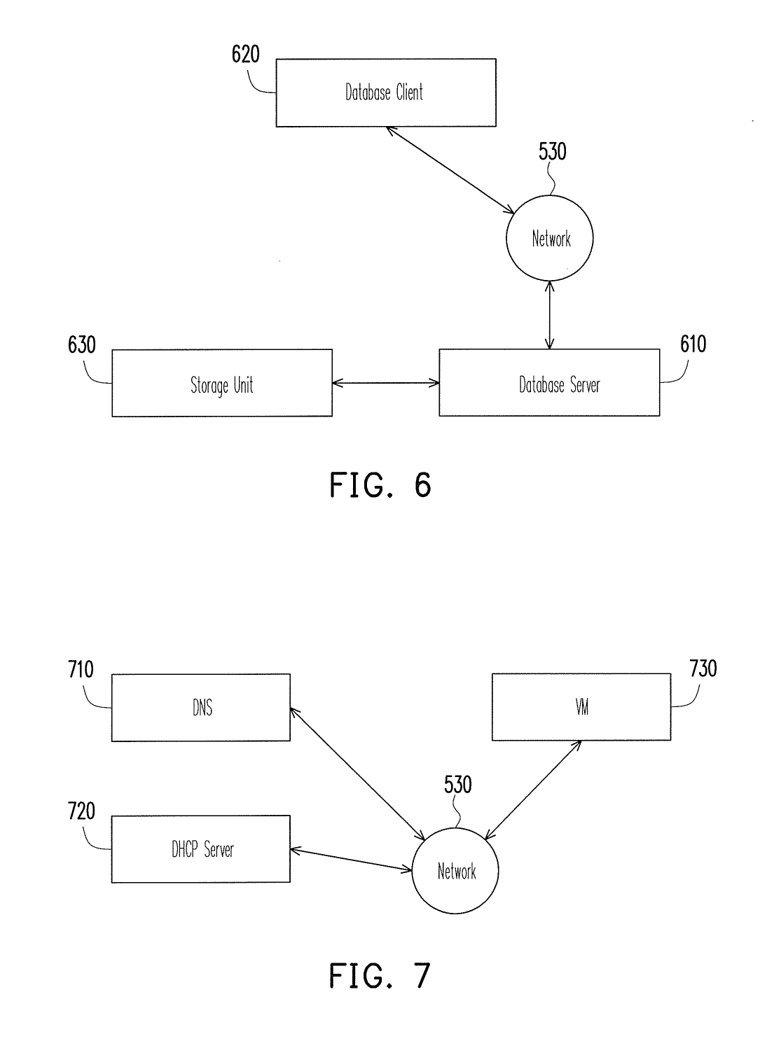

FIG. 7 is a schematic diagram illustrating architectures of a Domain Name Server (DNS) 710 and a Dynamic Host Configuration Protocol (DHCP) server 720 according to the first embodiment of the present invention. The DNS 710 and the DHCP server 720 are connected via the network 530. When a client varies an FQDN or a network address (i.e. VM MAC address) of a VM thereof, the VM will actively notify the DNS 710 and the DHCP server 720 to update the corresponding FQDN or network address of the VM.

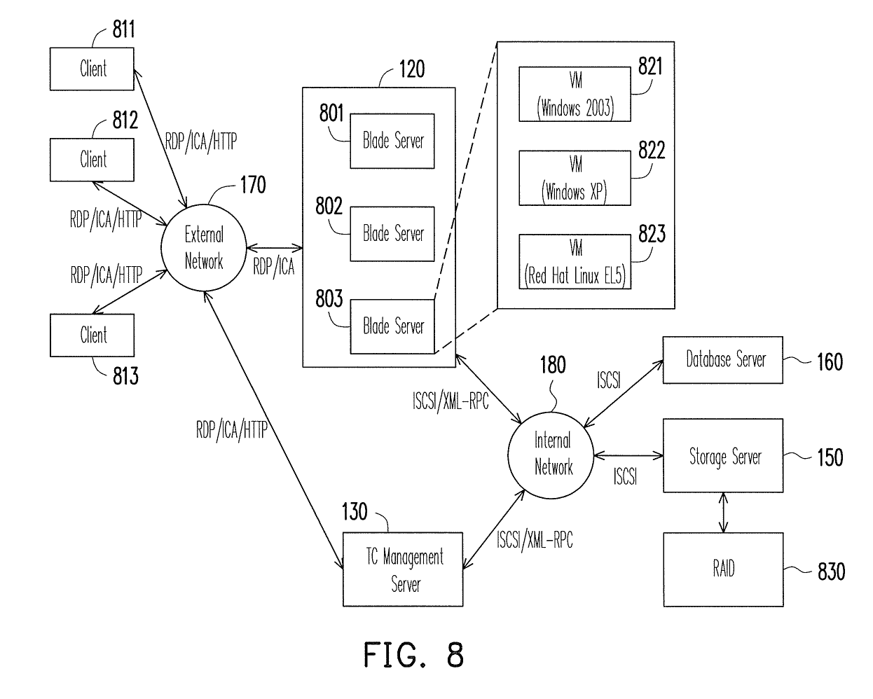

FIG. 8 is a block diagram of the internet server system according to the first embodiment of the present invention, for illustrating a process of connecting a thin client (TC) to a VM. The TC is connected to the external (or internal) network 170 by RDP or ICA and HTTP communication protocols. The computing server 120 is connected to the external (or internal) network 170 by RDP or ICA protocol. The thin client management server 130 is connected to the external (or internal) network 170 by RDP or ICA and HTTP communication protocols. Meanwhile, the computing server 120, the thin client management server 130, the database server 160, and the storage server 150 are connected to the internal network 180 by ISCSI, in which the computing server 120 and the thin client management server 130 can also be connected to the internal network 180 by XML-RPC protocol. The storage server 150 is connected to a RAID 830.

The computing server 120 includes three blade servers 801, 802, and 803, disposed therein. Each of the three blade servers 801, 802, and 803 can be executed with a plurality of VMs thereon. As shown in FIG. 8, there are three VMs executed on the blade server 803, in which VM 821 is a Windows® 2003 operation system, VM 822 is a Windows® XP operation system, and VM 823 is a RedHat Linux EL5 operation system. A client 811 is a personal computer, and a client 812 is a notebook computer, and a client 813 is a thin client apparatus.

An execution process of connecting the client 811 to the VM 821 is to be exemplified herebelow. In exemplifying the execution process, it is assumed that the VM 821 corresponding to the client 811 has been already created but not started yet, and the client 811 does not have a remote desktop protocol client (RDP) program.

At first, the client 811 enters a thin client webpage management window 301, and inputs a user account and a user password to the thin client management server 130. The thin client management server 130 checks whether the inputted user account and user password are correct or not. If the user account and the user password are confirmed as being correct, the thin client management server 130 then transmits a command to instruct the computing server 120 to start the VM 821. Then, the thin client management server 130 transmits an additional software to the client 811 and checks whether the client 811 has an RDP client program.

If the client 811 does not have an RDP client program, the client 811 will request an RDP client software from the thin client management server 130, and correspondingly the thin client management server 130 will feedback an RDP client software, a network address and an FQDN of the VM 821 to the client 811. The client 811 receives the RDP client software from the thin client management server 130, and executes the RDP client software. In such a way, the client 811 can be connected to the VM 821 of the blade server 803 corresponding to the computing server 120 by the RDP client software via the external (internal) network 170, and thus enters the VM 821 for operation.

### Second Embodiment

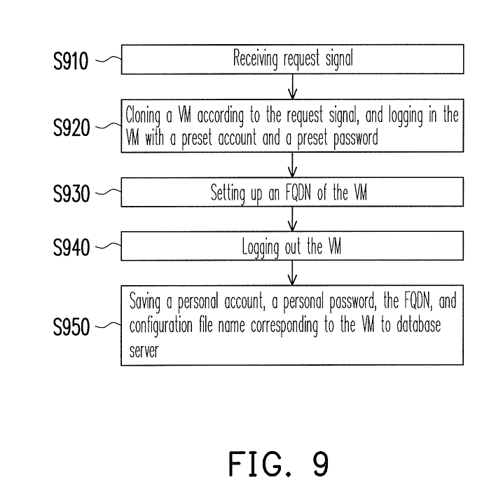

The present invention further provides a method for creating a VM and an account thereof. FIG. 9 is a flow chart illustrating a method of creating a VM and an account thereof according to a second embodiment of the present invention. Referring to FIGS. 1 and 9 together, first at step S910, a request signal is received. The request signal is an application sent by the client apparatus 110 to the internet server system for a VM. At step S920, a server administrator can clone a VM in response to the request signal, and log in the VM with a preset account and a preset password. In this case, the computing server 120 clones a new VM according to a preset VM module, and sets up an operation system, an authority and defines a related configuration setting values of the new VM, as shown in Tables 2 and 3.

Table 2 shows six preset Microsoft® Windows® system VM modules. The six modules include different combinations of operation system versions and system source allocations. Table 3 shows six preset Linux system VM modules. The six modules also include different combinations of operation system versions and system source allocations. Then, at step S930, FQDNs of the VMs are created. And at step S940, logging out the VM. Finally, at step S950, a personal account, a personal password, the FQDN, and a configuration file name corresponding to the VM are saved to a database server.

TABLE 2
Windows ® Operation System VM Modules

| User Level | VM Operation System | VM Allocated Sources |
|---|---|---|
| Level 1 | Microsoft ® Windows ® | 8 Virtual CPUs |
| | 2003 64 bit + | 1 GB memory |
| | office2007 + power | 4 Virtual NICs |
| | DVD player + Visio | 30 GB Storage Space |
| | 2003 | |
| Level 2 | Microsoft ® Windows ® | 4 Virtual CPUs |
| | 2003 32 bit + office | 1 GB memory |
| | 2003 + power DVD + | 2 Virtual NICs |
| | Visio | 20 GB Storage Space |
| Level 3 | Microsoft ® Windows ® XP | 2 Virtual CPUs |
| | 32 + office 2003 + | 1 GB Memory |
| | power DVD + Visio | 2 Virtual NICs |
| | | 15 GB Storage Space |
| Level 4 | Microsoft ® Windows ® | 2 Virtual CPUs |
| | 2003 64 bit | 512 MB Memory |
| | | 1 Virtual NIC |
| | | 10 GB Storage Space |
| Level 5 | Microsoft ® Windows ® | 1 Virtual CPU |
| | 2003 32 bit | 512 MB Memory |
| | | 1 Virtual NIC |
| | | 8 GB Storage Space |
| Level 6 | Microsoft ® Windows ® XP | 1 Virtual CPU |
| | | 256 MB Memory |
| | | 1 Virtual NIC |
| | | 8 GB Storage Space |

TABLE 3
Linux Operation System VM Modules

| User Level | User Level | VM Operation System |
|---|---|---|
| Level 1 | RedHat Linux | 8 Virtual CPUs |
| | Operation System EL 5 | 1 GB Memory |
| | AS 64 bit Complete | 4 Virtual NICs |
| | Installation | 30 GB Storage Space |
| Level 2 | RedHat Linux | 4 Virtual CPUs |
| | Operation System EL 5 | 1 GB Memory |
| | AS 64 bit Ordinary | 2 Virtual NICs |
| | Installation | 20 GB Storage Space |
| Level 3 | RedHat Linux | 2 Virtual CPUs |
| | Operation System EL 5 | 1 GB Memory |
| | AS 32 bit Complete | 2 Virtual NICs |
| | Installation | 15 GB Storage Space |
| Level 4 | RedHat Linux | 2 Virtual CPUs |
| | Operation System EL | 512 MB Memory |
| | AS 32 bit Ordinary | 1 Virtual NIC |
| | Installation | 10 GB Storage Space |
| Level 5 | Fedora Core 8 | 1 Virtual CPU |
| | Operation System 64 bit | 512 MB Memory |
| | | 1 Virtual NIC |
| | | 8 GB Storage Space |
| Level 6 | Fedora Core 8 | 1 Virtual CPU |
| | Operation System 32 bit | 256 MB Memory |
| | | 1 Virtual NIC |
| | | 8 GB Storage Space |

### Third Embodiment

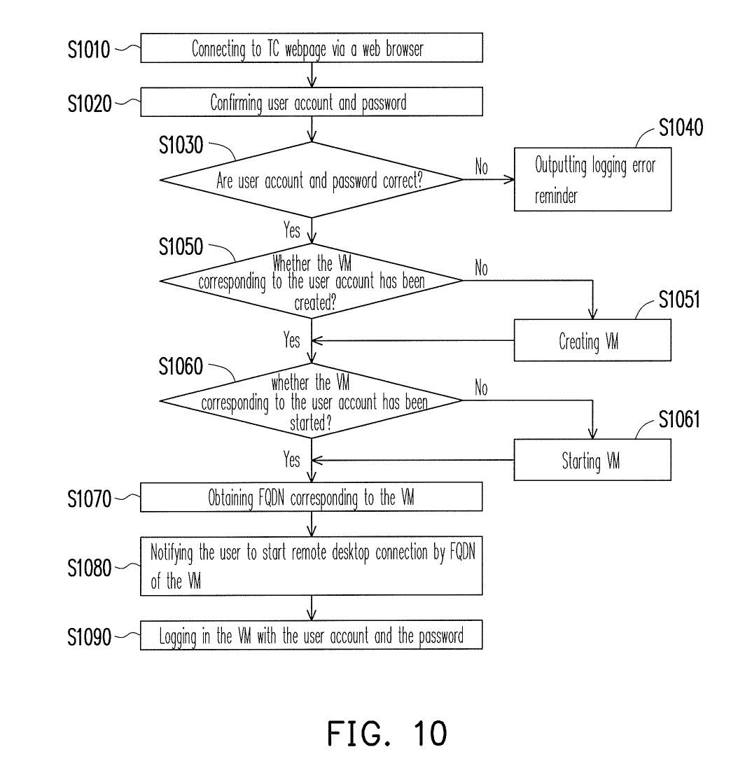

Viewing from another point, the present invention further provides a method of starting a virtual machine and an account thereof via a webpage. FIG. 10 is a flow chart illustrating a method of starting a VM via a webpage according to a third embodiment of the present invention. Referring to FIG. 10, first at step S1010, a client is connected to a thin client webpage via a web browser, e.g., Microsoft® Internet Explore (IE) or Linux Mozilla Firefox. Then at step S1020, a user account and a user password are confirmed. If in the step S1030, the user account and the user password are failed to be confirmed as being correct, a logging error reminder is outputted at step S1040, e.g., notifying the user that the account or the password is incorrect, please re-enter. Or otherwise if the user account and the user password are confirmed as being correct, then at step S1050, it is determined that whether a VM corresponding to the user account has already been created or started.

If the corresponding VM has not been created yet, then at step S1051, the VM is created. The VM can be created by cloning a new VM from a pre-stored VM module as shown in Tables 2 and 3. After the new VM is copied from the VM module, the thin client management server 130 starts the VM for setting up the VM. After being set up, the VM is then closed, and the flow goes to step S1060. If the corresponding VM has already been created, then the flow skips the step S1051 and directly goes to step S1060. At step S1060, it is determined whether the VM corresponding to the user account has been already started. If it has not been started, then the flow goes to executed S1061 to start the VM, and then goes to step S1070. If it has been started, then the flow directly goes to execute step S1070 to attain the FQDN corresponding to the VM.

Then, at step S1080, the user is notified to start a remote desktop connection by the FQDN of the VM. The thin client management server 130 transmits an additional software (including a network address of the VM) to the thin client, for checking whether the client has an RDP client program. The client executes the additional software, and it is checked that the client has an RDP client program, the received network address of the VM is then directly used to connect the VM by the RDP client program. If it is checked that the client does not have such an RDP client program, then the thin client management server 130 will be reminded with result, and correspondingly the thin client management server 130 will feedback a corresponding RDP client software and a network address to the thin client.

In summary, the present invention provides an internet server system including at least one client apparatus, a computing server, a thin client management server, a storage unit, and a storage server. The internet server system is adapted for providing a VM to the client apparatus for use. The thin client management server is adapted for managing adding, deleting, connection and disconnection operations of a Xen server, adding, deleting and transferring operations of a VM module, and adding, deleting and backup, recovery, account management, and configuration data accessing operations of the VM. Further, the thin client management server is also adapted to lively migrate a VM to other Xen servers, according to workloads of different blade servers.

The present invention further provides a method of creating a VM and an account thereof. The method allows the client to create a new VM, and open a web browser, and then connects to the VM by an RDP protocol, as desired.

The internet server system according to the present invention provides a complete server architecture, including a client apparatus, a computing server, a thin client management server, a storage server, a storage unit, external and internal networks. The internet server system is adapted for providing a VM of operational environment desired by the client. The internet server system has the function of VM management, access of configuration, VM module management, and Xen server management. With such an internet server system according to the present invention, an enterprise user is allowed to construct a complete server system, to provide their staff desired operation environments, thus enforcing convenience and efficiency of information management and computer system maintenance.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An internet server system, comprising:
at least one client apparatus;
a computing server, for providing the client apparatus a virtual machine (VM);
a thin client management server, for managing the VM and determining a system source corresponding to the VM;
a storage unit, for storing an operation system corresponding to the VM; and
a storage server, connected to the storage unit, for managing an access authority of the storage unit,
wherein the client apparatus is connected to the computing server and the thin client management server via an external or an internal network, and the storage server is connected to the thin client management server and the computing server via an internal network.

2. The internet server system according to claim 1, wherein a communication protocol applied between the client apparatus, the computer server, and the thin client management server comprises a Remote Desktop Protocol (RDP) or an Independent Computing Architecture (ICA), and a Hypertext Transfer Protocol (HTTP).

3. The internet server system according to claim 2, wherein a communication protocol applied between the computing server and the thin client management server comprises an Extensible Markup Language Remote Procedure Call (XML-RPC) communication protocol.

4. The internet server system according to claim 1, wherein a communication protocol applied between the storage server, the thin client management server, and the computing server comprises an Internet Small Computer System Interface (ISCSI) protocol.

5. The internet server system according to claim 1, wherein the client apparatus comprises a thin client apparatus, a personal computer, or a notebook computer.

6. The internet server system according to claim 1, wherein the computing server comprises a plurality of blade servers.

7. The internet server system according to claim 6, wherein the thin client management server is adapted for adjusting a quantity of VMs assigned to each of the blade servers for computation, according to computation loads of the blade servers.

8. The internet server system according to claim 1, wherein the thin client management server is further adapted for managing a user account, transferring the VM, monitoring a status of the VM and connecting the VM to a thin client.

9. The internet server system according to claim 1, wherein the storage unit comprises a plurality of hard disks, and the hard disks are Serial Attached SCIS (SAS) interfaces, or Serial Advanced Technology Attachment (SATA) interfaces.

10. The internet server system according to claim 1, wherein the thin client management server provides an RDP client environment, an ICA client environment, or an HTTP client environment to the client apparatus.

11. The internet server system according to claim 1, wherein the thin client management server comprises a virtual machine management module (conVirt(GUI)/xm).

12. The internet server system according to claim 1, wherein the VM is a Xen VM.

13. The internet server system according to claim 1, wherein the VM comprises a virtual disk space and an operation system.

14. The internet server system according to claim 13, wherein the operation system comprises a Microsoft® Windows® operation system, or a Linux operation system.

15. The internet server system according to claim 13, wherein the storage unit is a redundant array of independent disk (RAID) system.

16. The internet server system according to claim 1, wherein when an address of the VM or a Fully Qualified Domain Name (FQDN) of the VM is varied, the VM notifies a domain name server (DNS).

17. The internet server system according to claim 1, wherein the storage server is an Internet Small Computer System Interface (ISCSI) server, a Network Attached Storage (NAS) server, or a Fibre Channel server.

18. The internet server system according to claim 1, further comprises:
a database server, for saving the account, the password, the FQDN, a configuration file name, and an internet address corresponding to the VM.

19. A method of creating a virtual machine (VM) and an account, comprising:
receiving a request signal;
cloning a VM according to the request signal and logging in the VM with a preset account and a preset password;
setting up a Fully Qualified Domain Name (FQDN) for the VM;
logging out the VM; and
saving a personal account, a personal password, the FQDN, and a configuration file name corresponding to the VM to a database server.

20. A method of starting a virtual machine (VM) via a webpage, comprising:
connecting to a thin client webpage via a web browser;
confirming a user account and a password;
creating or starting a virtual machine (VM), and creating or attaining a Fully Qualified Domain Name (FQDN) corresponding to the VM, when the user account and the user password are confirmed as being correct;
notifying a user to start a remote desktop connection by the FQDN of the VM;
connecting to the VM via a remote desktop client; and
logging in the VM with the user account and the password.

21. The internet server system according to claim 20, wherein when the user account and the password are failed to be confirmed as being correct, a logging error reminder is outputted.

22. The internet server system according to claim 20, wherein the step of starting the VM when the user account and the password are confirmed as being correct of the foregoing method further comprises:
directly retrieving the FQDN corresponding to the VM, if the VM corresponding to the user account has been already started; and
starting the VM, if the VM corresponding to the user account is not yet started.
